(19) United States
(12) Patent Application Publication
(10) Pub. No.: US 2009/0216590 A1
(43) Pub. Date: Aug. 27, 2009

(54) Inferring System Goal Values in An Inverse Goal Lattice

(76) Inventor: Kenneth J. Hintz, Fairfax Station, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/334,060

(22) Filed: Dec. 12, 2008

Related U.S. Application Data
(60) Provisional application No. 61/013,186, filed on Dec. 12, 2007.

(51) Int. Cl. G06Q 10/00

(52) U.S. Cl. 705/7

(57) ABSTRACT

A system for inferring relative system goal values in an inverse goal lattice including: a goal identification module, an inverse goal lattice configuration module, a goal value assignment module, an included goal value allocation module, and an including goal value assignment module. The goal identification module identifies goals for accomplishing system objective(s). The inverse goal lattice configuration module applies an ordering relation to goal(s) to configure the inverse goal lattice. The inverse goal lattice interconnects goals with several levels having “including goals” and “included goals.” The goal value assignment module assigns values to included goal(s) at a lowest level of the inverse goal lattice. The included goal value allocation module allocates goal value(s) from included goal(s) to including goal(s) using a goal value allocation function. The including goal value accrual module assigns an including goal value using: allocated goal value(s) and goal value accrual function(s).

### CROSS-REFERENCE TO RELATED APPLICATIONS

This application claims the benefit of U.S. Provisional Application No. 61/013,186, filed Dec. 12, 2007, entitled “Method and Apparatus of Inferring Relative Utilities for each of Several System Goals Based on Observed Events,” which is hereby incorporated by reference in its entirety.

### BACKGROUND OF THE INVENTION

Conventional decision making models include abstract goals and discrete action tasks, but do not provide a mechanism for quantitatively relating the two. For that reason, it is difficult to determine how observed actions or outputs of a system relate to the relative importance of system goals as specified by the operators of the system when the utilities of system goals are not directly observable. In a rational system, the actual observed actions which result from a system are the result of the application of top-most, system goals. In a previous patent, U.S. Pat. No. 6,907,304, entitled “Method and Apparatus of Measuring a Relative Utility for Each of Several Different Tasks Based on Identified System Goals,” to Hintz et al. the apportionment of these higher, also known as including goals, among lower, also known as included goals, was disclosed as a method of determining the value of taking real, measurable actions, primarily for the management of a sensor system. Goals that are neither included nor including are unrelated goals.

This system disclosed in U.S. Pat. No. 6,907,304 is useful to model the behavior of highly observable positively and measurably linked systems. These linked systems include conventional adversarial forces. However, recent years have seen an advent of asymmetrical, amorphous adversarial forces such as terrorist organizations.

### BRIEF DESCRIPTION OF THE DRAWINGS

Embodiments of the present invention will become more fully understood from the detailed description given herein below and the accompanying drawings which are given by way of illustration only, and thus are not limitative of the present invention, and wherein:

FIG. 1 is a diagram of a uniformly apportioned inverse goal lattice structure in accordance with an aspect of an embodiment of the present invention;

FIG. 2 is a diagram of a non-uniformly apportioned inverse goal lattice structure in accordance with an aspect of an embodiment of the present invention;

FIG. 3 is a block diagram of a system using an inverse goal lattice in accordance with an aspect of an embodiment of the present invention;

FIG. 4 is a diagram of a multi-layer uniformly apportioned inverse goal lattice structure in accordance with an aspect of an embodiment of the present invention;

FIG. 5 is a flow diagram showing actions to measure a relative utility for each of several top-most system goals based on value accrual from included goals according to an aspect of an embodiment of the present invention;

FIG. 6 is a diagram of an example goal lattice structure used to describe an aspect of an embodiment of the present invention;

FIG. 7 is a flow diagram showing actions for inferring relative system goal values in an inverse goal lattice according to an aspect of an embodiment of the present invention;

FIG. 8 is a block diagram of an example system for inferring relative system goal values in an inverse goal lattice goal lattice according to an aspect of an embodiment of the present invention; and

FIG. 9 is a block diagram of inverse goal lattice processing modules according to an aspect of an embodiment of the present invention.

### DESCRIPTION OF THE EMBODIMENTS

Embodiments of the present invention may be used to analyze the actions of new types of systems such as the asymmetric, amorphous adversarial forces with limited observability. These embodiments apply observations of real, measurable actions, also referred to as activities, to infer the relative values of the top-most, system goals.

If the relative values of a first system's system goals are known or inferred, then the effectiveness of actions taken by a second system which interacts with the first system can be estimated or predicted. Also, an estimate of the first system's relative system goal values may be used as an input to guide in the selection of the second system's actions to cause a desired change in the first system's relative system goal values.

Embodiments of the present invention relates to methods and apparatus of inferring a relative utility for each of a plurality of system goals which comprise a system objective. More particularly, embodiments of the present invention relates to methods, systems, and apparatus for quantifying the relative contribution of real, measurable actions, also known as bottom-most goals, or activities, to a set of broader goals, and for inferring the relative value of system goals, also known as top-most goals, based on the quantified relative contribution of the included goals, also known as real, measurable actions, or activities. In some embodiments, a lattice is created based on an ordering relation and relative values associated with real, measurable actions. These values of included goals are apportioned to the higher level goals using their position in the lattice as including, included, or unrelated goals.

It is to be understood that descriptions are intended to provide further explanation of the invention as claimed. Thus, it should be understood that the description and specific examples, while indicating embodiments of the invention, are given by way of example only. Various changes and modifications that are within the spirit and scope of the invention will become apparent to those skilled in the art from this detailed description. In fact, other objects, features, and characteristics of the present invention; methods, operation, and functions of the related elements of the structure; combinations of parts; and economies of manufacture will surely become apparent from the following detailed description of the embodiments and accompanying drawings, all of which form a part of the specification, wherein like reference numerals designate corresponding parts in various figures.

Some embodiments of the present invention relate to methods, systems, and apparatus for inferring the relative value of system goals, comprising one or more of the following actions in any effective order:
identifying a plurality of goals for accomplishing a system objective;
defining an ordering relation on the plurality of goals;
applying the ordering relation to the plurality of goals to create a lattice;
assigning a value to each goal, e.g., with an arbitrary or reasoned assignment of values to the bottom-most goals, such that the bottom-most goals sum to a constant, e.g., a value of 1.0, wherein the value of each included goal can be apportioned among its including goals and the value of each including goal is assigned by accruing the value apportioned to it by its included goals;
normalizing the values across the set of the next most inclusive goals; and/or
associating a relative value to each of the top-most goals and outputting these as a set of relative values of the system goals.

A system objective is generally a top-level purpose. For example, in a business, a system objective can be to achieve a dominant share in the market, to develop new products, or to achieve a certain level of profitability. Along these lines, the method can be useful for inferring the relative value of top-most goals of a competing business.

To perform the method, a plurality of goals for accomplishing the system objective can be identified. By the term “goal,” it is meant any task, activity, end-result, etc., which is to be considered in order to accomplish a system objective. In the business example of achieving a dominant share in the market, goals can be, e.g., to open a new store, to purchase the land for the new store, to hire a contractor to build the store, to get the necessary building permits, to establish an internet connection to the store, to analyze the market, to hire a cleaning company, to develop new products, to conduct applied research, to conduct basic research, to produce a product for sale, to manufacture a product, to advertise a product, to create a sales force, to create a support staff, to create a scientific staff, to conduct market research, etc. All such activities can be characterized as goals and the act of selecting which goals to consider in order to achieve the system goal can be characterized as “identifying a plurality of goals.” Goals may be identified many ways including by a human operator, by automatically using AI-based algorithms, etc.

For the example of an armed conflict which involves the placement of improvised explosive devices (IED), goals used to construct a goal lattice might include: discourage economic recovery; accrue power; cause foreign investors to withdraw; attract attention to cause; generate sympathy for cause; provide religious support for relatives; establish local rural control; control inhabitants; establish local urban control; commemorate an event; assassinate an individual; ensure terrorist escape; disrupt communications; and generate propaganda.

After goals are identified, in a preferred embodiment of the invention, an ordering relation may be defined. The phrase “ordering relation” means any property that can be said to hold (or not to hold) for two objects in a specified order such that x<y, y<x, or x and y are unrelated (where “<” means “included in”). If x<y and y<x, then x=y. Also, if x<y, and y<z, then x<z. The combination of an ordering relation and a set of objects (in this case, goals) yields a partially ordered set (POSET).

An ordering relation may be used as a means of classifying the multiplicity of goals as (a) “included goals” (i.e., goals which are included in, are a part of, or contribute to the accomplishment of high-level goals), (b) “including goals” (higher-level goals which encompass “included goals”, and (c) “unrelated goals.”

An “including goal” is one which is comprised of one or more included goals, i.e., included goals are “included” in an including goal. In the business example above, the goal of “developing new products” is an including goal which has the following included goals: conducting basic research, conducting applied research, creating a scientific staff, and conducting market research. Goals such as creating a sales force and manufacturing a product may be unrelated to the goal of “developing new products” and therefore can be characterized as “unrelated goals.”

The ordering relation may be used to create a lattice. By the term “lattice” it is meant, a representation of the relationship among the goals as imposed by the ordering relation, preferably having a greatest lowest bound and a least upper bound for each pair of goals. The representation can be graphical (e.g., a Hasse diagram), a matrix, or any suitable form. A lattice can be created by any conventional or state-of-the-art method. See, e.g., James and James Mathematics Dictionary [“Lattice: A partially ordered set in which any two elements have a greatest lower bound (g.l.b.) and a least upper bound (l.u.b.), the g.l.b. of a and b being an element c such that c<=a, c<=b, and there is no d for which c<d<=a and d <=b, and the l.u.b. being defined analogously] and Naive Set Theory by Paul R. Halmos, 1960.

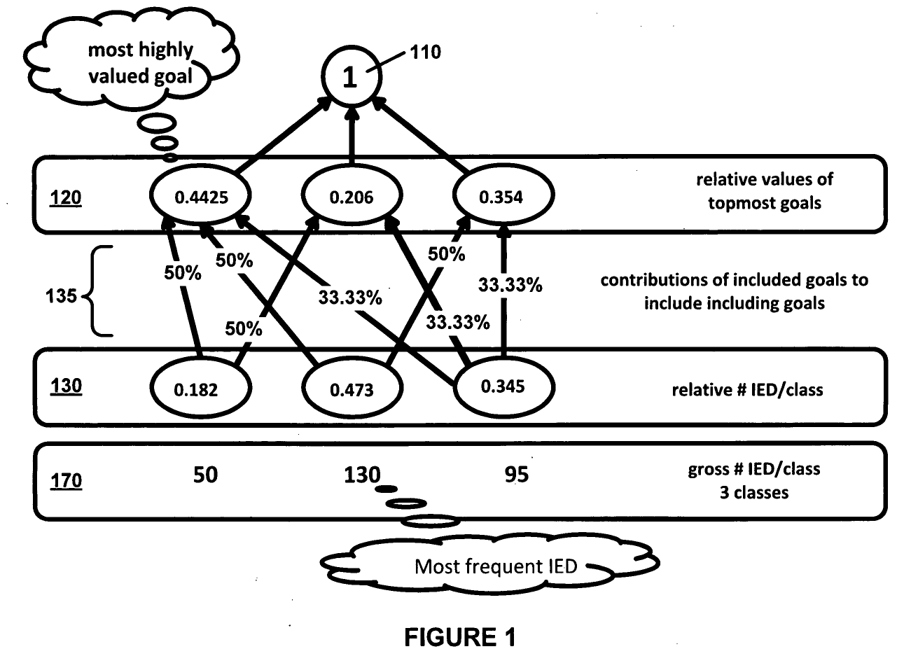

Goals which are unrelated by the ordering relation, and are all included in one or more including goals, can be characterized as being on a “level.” (See, e.g., FIG. 1, levels 130 and 120). Mathematically, these unrelated goals have a “least upper bound (l.u.b.)” as described in the definition of lattice previously presented.

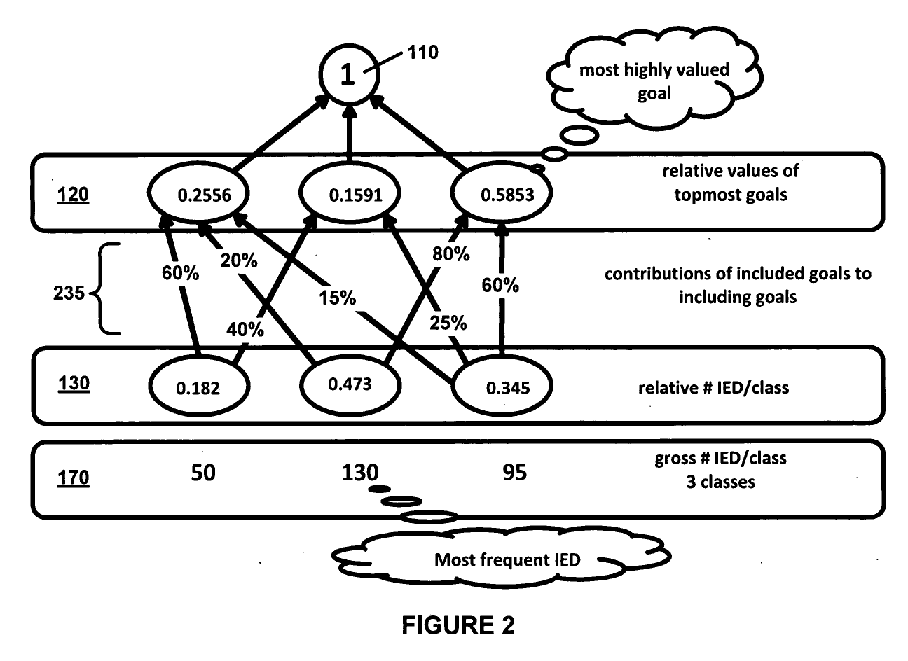

After a lattice has been created, a further action of the invention preferably comprises assigning a value to each of the goals in the lattice. The lattice and the assigned values are referred to as a “goal lattice.” Values of the goal lattice can be assigned by any effective method which apportions the value of included goals among the corresponding including goals. Apportionment can be arbitrary, uniform, calculated using an algorithm or function, subjective by a human operator evaluating the relative utility of each included goal to an including goal, etc. For instance, with reference to FIG. 1, the bottom-most goals, i.e., the real, measurable actions which have been measured or estimated, can be assigned values which sum to an arbitrary number, e.g., 1. The value of each included goal can be apportioned uniformly 135 among the including goals as shown in FIG. 1, they can be apportioned according to a user-preference 235 as shown in FIG. 2, they can be apportioned automatically by an algorithm, or function, or any other suitable means of apportioning values among including goals. The bottom-most goals values may also be assigned according to some measured or observed relative frequency of occurrence of the real, measurable action or class of real, measurable actions.

In accordance with one embodiment, the values may be assigned such that the value of each included goal is apportioned among its including goals and the value of each including goal is assigned by summing the values apportioned to it by its included goals. Such actions for uniform apportionment are illustrated in FIG. 1.

An assignment of value to a goal does not have to be static. Values can be also determined continuously, intermittently, periodically, etc, by any mathematical function which automatically computes and updates their values based on changes.

Once values are assigned to bottom-most goals in the lattice, the relative value of the system goals can be determined; hence this lattice is called an “inverse goal lattice” to differentiate it from the top down allocation of relative values which is performed by the goal lattice, U.S. Pat. No. 6,907,304. The relative values of the system goals in the inverse goal lattice can be statically or changing over time. System goals changing over time can lead to a differential inverse goal lattice. The differential inverse goal lattice can be used to infer the effects of a first system's behavior on the relative values of the system goals of a second system.

As mentioned, methods and systems of the present invention can be used for a variety of purposes, including, e.g., business applications, military system design and control applications, community planning research and development, employee compensation, etc., in virtually any environment in which resource allocation is practiced and in which a user can apportion values among the various including goals from included goals.

For example, an embodiment of the present invention can be used to determine whether actions taken to interdict or remediate an adversary's use of landmines, improvised explosive devices, or other potentially harmful device have been effective. This effectiveness is measured by the change in the relative values of the top-most goal values as inferred by the measurement of the changing effectiveness of the adversary's weapons. An adversary is reasonably expected to change its relative top-most goal values in response to decreased or increased effectiveness of its real measurable actions. These real, measurable actions may be the only events which are observable and the present invention addresses inferring relative system goal values from this sparse, noisy, and/or incomplete data.

A goal lattice can be stationary or non-stationary. For instance, once an ordering relation among a plurality of goals is created, an assigning action can be performed at different times to adjust for changing user-preferences, or other measures of goal utility.

In an embodiment of the invention, a method may be applied to infer the relative value of the system goals of a military adversary. To perform value inference comprehensively, values can be assigned to designate the significance of each observed adversarial event, e.g., a successful IED, an unsuccessful IED, or a detected and disarmed IED, since not all adversarial events are observable, e.g., those IEDs which are not detected and are not detonated. To that end, some embodiments may involve a system and method for assigning values to IED events, which values represent the relative contribution of those events to the accomplishment of one or more of several system goals.

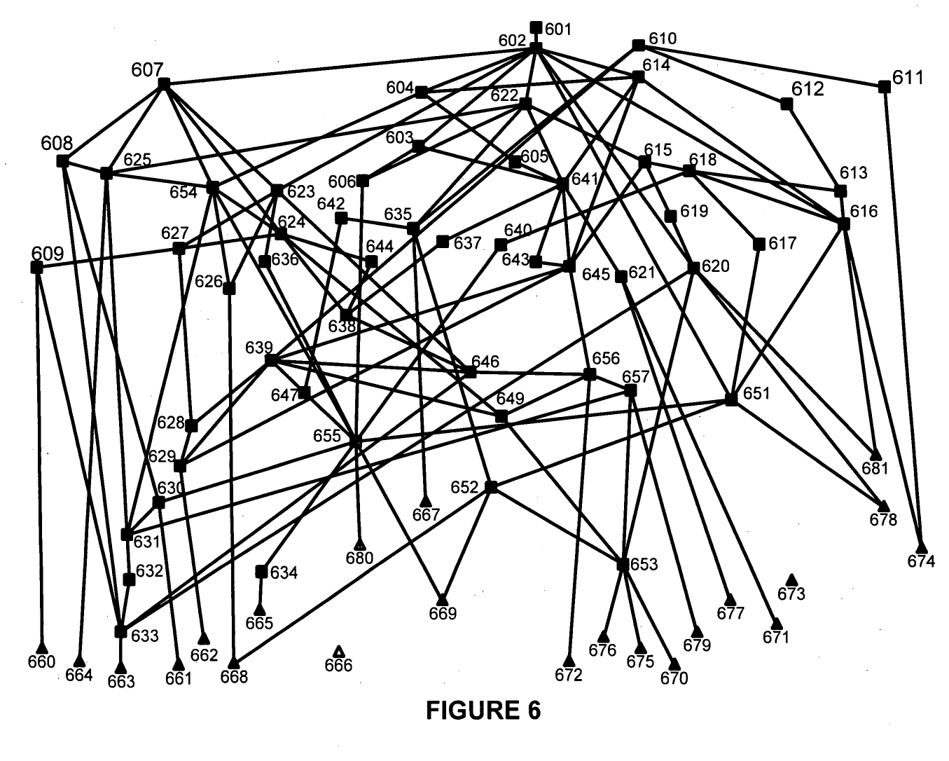

FIGS. 1 and 2 illustrate examples of uniformly and non-uniformly apportioned inverse goal lattice structures in accordance with embodiments of the present invention, demonstrating a relationship among goals that are related in accordance with an ordering relation. Specifically, as shown in FIGS. 1 and 2, two lattice structures are shown, each having two layers of nodes (e.g., 120-130) however many more layers can exist between them, each node representing a goal as shown in FIG. 6. The level of abstraction for each node within the lattice structure is such that the top-most nodes represent system goals having a highest order of abstraction (e.g., conceptual, tactical goals also known as “soft” goals) while the bottom-most nodes represent system goals and tasks having the lowest order of abstraction (e.g., real and measurable goals also known as “hard” goals or activities). In other words, since the bottom-most goals have the lowest order of abstraction, they generally represent specific tasks that may be performed to accomplish the higher order system goals. In these lattice structures, goals on the same level have the same level of abstraction.

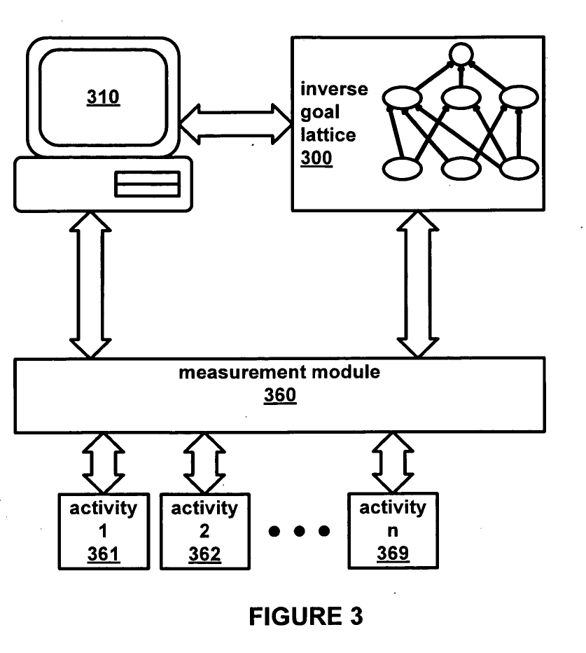

FIG. 3 is a block diagram of a system using an inverse goal lattice in accordance with an aspect of an embodiment of the present invention. A computer 310 may be configured to read a computer readable medium that stores a computer program comprising code segments capable of performing processes in accordance with the concepts of the present invention. The computer 310 may include at least a video display device and a main unit including a main processing board and storage device. Main processing board may include programmed processor and computer-readable memory. Computer-readable memory can include a random access memory (RAM), a read only memory (ROM), or any volatile or non-volatile memory device. Storage medium is another computer-readable memory device which can include a fixed hard disk drive and/or a removable storage medium for a non-fixed disk drive such as a floppy disk or a digital versatile disk (DVD). A program is stored on one of the computer-readable memory devices and may cause the processor to implement a method according to an embodiment of the invention.

Alternatively, a host device may be used to download a program which causes the processor to implement the method according to an embodiment of the invention, in which case, the computer-readable medium in which the program is embodied takes the form of a propagated signal.

The computing machine 310 may interface with a measurement device 360 configured to collect activity measurements (361, 362, . . . , 369). These measurements may be used to populate the lowest level included goals in the inverse goal lattice 300. The inverse goal lattice may be instantiated many ways such as in a database or system that includes programmable hardware such as, but not limited to, application-specific integrated circuits (ASICs), field programmable gate arrays (FPGAs), and complex programmable logic devices (CPLDs). Using programmable hardware devices might allow for faster analysis of complex lattice structures than when a database is used. In the embodiment of the present invention shown in FIG. 3, a computing machine 310 may be used to interface with both a measurement module 360 and an inverse goal lattice 300. In this case, the measurement device 360, once configured, may collect activity data from activity sensors (see 361, 362 . . . , 369) and apply them to specific included goals in the inverse goal lattice 300 without the overhead of computing machine 310. Computing machine 310 may then monitor the results of the inverse goal lattice 300 without having to engage in potentially lengthy software computations.

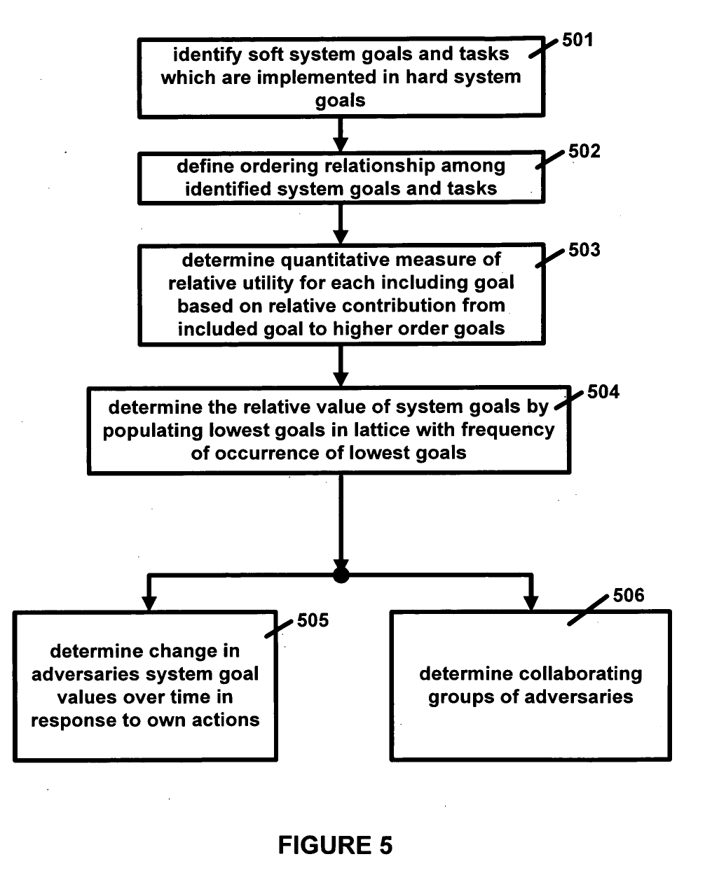

FIG. 5 illustrates a flowchart of steps performed by a method used to measure a relative utility for each of several different goals based on a system objective according to the present invention. As shown in action 501 of FIG. 5, the first stage in the development of the goal lattice involves an identification of the broadest conceived set of tactical and strategic goals. Then, more specific system goals are identified which are capable of accomplishing the broadest set of goals, independently or as a group.

As shown in action 502 of FIG. 5, the theory of orderings or ordering relations is applied by the present invention to relate system goals for a military adversary and the observable tasks used to accomplish those systems goals. In general, this theory dictates that a partially ordered set is comprised of two components, a set of elements and an ordering relation defined on that set.

X={S,≦}

If the ordering relation relates every element to every other element, then the set and ordering relation form a totally ordered set or a chain. For example, if the set includes all integers and the ordering relation is the simple arithmetic “less than,” then we have a totally ordered set because every integer is “less than” some other integer. Conversely, if the set and ordering relation do not relate all elements but each pair of elements have both a greatest lower bound (g.l.b) and a least upper bound (l.u.b), then the set and ordering relation form a partially ordered set (POSET), also called a lattice. For a POSET, the inclusion relationship must meet the three requirements of reflexivity, asymmetry and transitivity. An example of an inclusion relation can be shown with respect to the set:

S={A,B,C},

where the ordering relation is defined as “is a subset of.” Clearly {A, B} is a subset of {A, B, C}, but {A, C} is not a subset of {A, B}.

In action 502, the ordering relation is defined as “(this included goal) is necessary to achieve (this other including goal)”. By applying this ordering relation to the set of goals, a lattice structure is achieved, such as that shown in FIG. 1 or that shown in FIG. 2.

Next, in action 503, a quantitative measure of relative utility is determined for each goal based on the relative contribution of that included goal to the accomplishment of including goals. This process involves two actions: included goal value apportionment to including goals and including goal value accrual.

Included goal value apportionment is the bottom up process of forced distribution of an included goal's value among its directly including goals. In this action, each included goal may be ignorant about whether any other included goal contributes to the accomplishment of the including goals. The lattices of FIGS. 1 and 2 are useful for illustrating the relationship among subservient (included) and dominating (including) goals. Although these lattices lack quantitative information about individual goals, they show an ordering relation between what might be called “soft” goals nearer the top and “hard” goals nearer the bottom, where “soft” goals generally refer to conceptual and strategic objectives and “hard” goals generally refer to finite and measurable, real, estimable, or observable.

If the ordering relation indicates that each included goal contributes to each including goal, then it is straightforward to impose on the lattice a zero-sum (or in this example, a 1-sum) distribution of goal values from an included goal to its including goals. That is, if we assume a sum of the values of the bottom-most goals of one (1), then each including goal which directly benefits from the accomplishment of that bottom-most goal accrues something of that value, and hence the value is distributed among the higher order including goals. This is readily apparent from the simple inverse goal lattice shown in the left half of FIG. 1. In this lattice, the value of each included goal is uniformly distributed among the related including goals, a distribution that follows from an assumption that each directly included goal contributes equally to the related including goal.

For example, the leftmost, bottom-most goal of FIG. 1 has two (2) including goals. Assuming the leftmost, bottom-most goal has a value of 0.182, the values apportioned to its including goals will be equal to the value of the leftmost, bottom-most goal plus values accrued from other included bottom-most goals. If each of the two (2) including goals make an equal contribution to the next highest included goal on equal value based on its relative contribution, each of the two (2) including goals would be assigned a contribution of 0.5*0.182=0.091 to each of the including goals value.

Similarly, of the two (2) dominant, or including goals that include the leftmost, bottom-most goal, the leftmost, top-most goal is an including goal having three (3) subservient or included goals. Thus, the value of the left most goal is accrued from these included goals. Its value is assigned as the sum of the values contributed from each of the three (3) included goals, resulting in an accrual of one half (½) of the value of the bottom-most, leftmost value (e.g., 0.5*0.182=0.091) plus one half (½) of the value of the bottom-most, middle goals (e.g., 0.5*0.473=0.237) plus one third (⅓) of the value of the bottom-most, rightmost goal (e.g., 0.33*0.345=0.114) for a total value assigned to the including goal of 0.441 assuming each included goal apportions equal contributions of its value to its including goals.

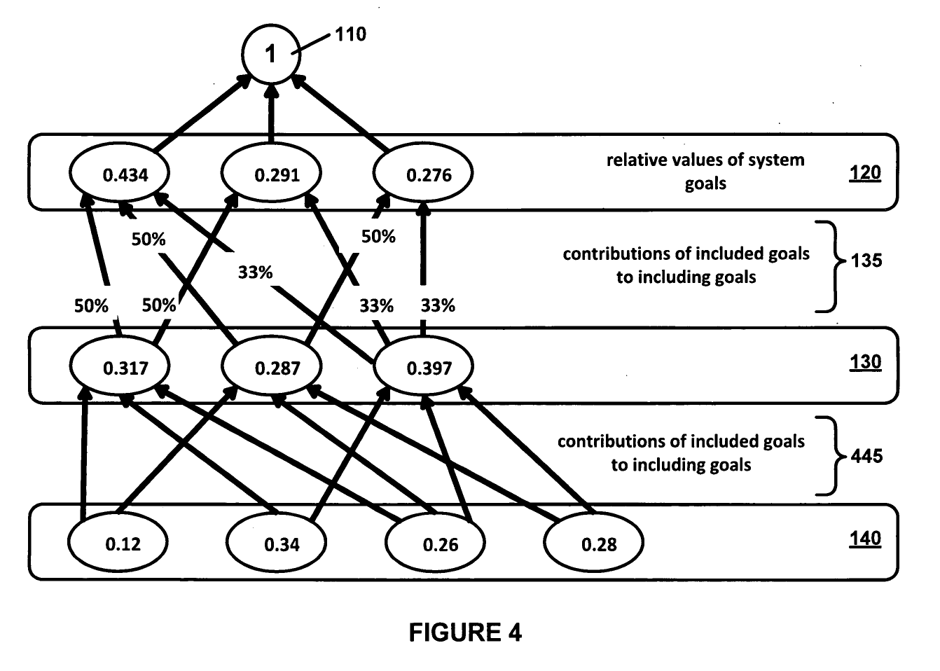

A multi layer inverse goal lattice is shown in FIG. 4 demonstrating equal apportionment of the values of the bottom-most goals to a next most inclusive layer. The values of the goals in that layer are accrued from the included goals and then reapportioned among the goals in the next most inclusive layer.

Uniform apportionment of values among including goals, as shown in FIG. 1, is the exception rather than the norm. It is more likely that some including goals accrue more value from the accomplishment of the included goal than other including goals, resulting in higher relative value apportionment from those included goals. An example of this is shown in the goal lattice of the FIG. 2, in which the values of including goals are not equally distributed among the included goals.

In addition, the values of some including goals receive contributions from more than one included goal. For instance, among the goals on level 120 of the lattice structure shown in FIG. 1, the value of the left most goal (0.4425) receives contributions from all of the goals of level 130. Therefore, assuming equal apportionment of values from the including levels to included levels, 50% of the value of 0.181 represents a contribution of 0.091 from the left most goal, 50% of the value of 0.473 represents a contribution of 0.2365 from the central goal, and 33.33% of the value of 0.345 represents a contribution of 0.115 from the rightmost goal of level 130. The process of associating values from plural including goals to a single included goal is the second part of action 503, generally referred to as goal value accrual, which will be described hereinafter.

Generally, the accomplishment of an included goal contributes value to more than one including goal and as such, should apportion value based on its contribution to each of those including goals, even if it is only included in a single including goal. Once the included goal values are apportioned among including goals, it is simple to perform upward goal value accrual by summing the contribution each included goal makes to the goals which includes it. Through this process, each including goal in the lattice acquires its value which is then apportioned among its including goals. FIGS. 1 and 2 show value accrual as well as value apportionment.

The process of generating a goal lattice can therefore comprise actions of identifying all relevant goals; ordering the goals in a lattice, and for each layer in the lattice, apportioning each included goal's value among directly including goals and accruing values at each including goal. By directly including is meant the least upper bound.

Computationally this is a remarkably simple procedure once the off-line task of identifying goals and ordering them has been accomplished. The simplicity of the computation allows for real-time updating of the inverse goal lattice, and hence the values of relative system values, thus inferring their relative importance in direct relationship to a measure of the included goals which have been accomplished.

Action 504 shows the initial population of the bottom-most layer of the lattice by the relative frequency of occurrence of particular observable real, measurable actions or action classes. After actions 501-504 of FIG. 5 are performed, any or all of actions 505-506 may be performed. In action 505, the result of the inverse goal lattice is stored at various times and the change in the relative values of the top-most goals with time or as a result of a second systems action is used to evaluate the second system's effectiveness.

In action 506, the inverse goal lattice can be computed for different subgroups of adversaries. Those subgroups which can be determined geographically or by ethnicity or by religious affiliation to have similar system level goal values can be effectively engaged with similar tactics.

FIG. 6 illustrates an example of a particular goal lattice structure used to describe one implementation of the present invention. The following provides a detailed example of the present invention applied to generate the goal lattice of FIG. 6.

A benefit of the inverse goal lattice approach is that it allows one to quantify, make measurable, and infer the value of amorphous, non-measurable, “soft” goals.

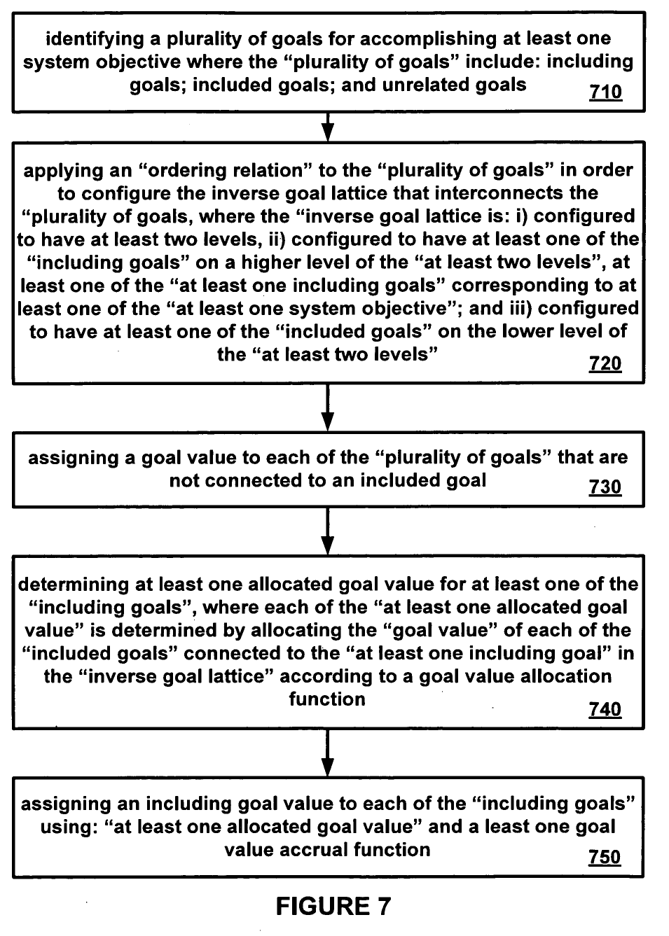

FIG. 7 is a flow diagram of yet another embodiment of the present invention that shows actions for inferring relative system goal values in an inverse goal lattice. At action 710, a plurality of goals may be identified that may be used to accomplish at least one system objective. As previously discussed, the “plurality of goals” may include: including goals; included goals; and unrelated goals.

Action 720 applies the “ordering relation” to the “plurality of goals” to configure the inverse goal lattice. The ordering relation may include an inclusion relation. The inverse goal lattice should be configured to interconnect the “plurality of goals” and be configured to: have at least two levels; have at least one of the “including goals” on a higher level of the “at least two levels”, at least one of the at least one “including goals” corresponding to at least one of the at least one system objective; and have at least one of the “included goals” on the lower level of the “at least two levels”.

A goal value may be assigned to each of the “plurality of goals” that is not connected to an included goal at 730. These goals normally reside at a lowest level of an ordering within the inverse goal lattice 300. These goal value(s) may be assigned in many ways. For example, they may be assigned by direct observation of an event. Events may be physical events or virtual events. Physical events generally occur in the physical world such as an explosion or population increases in a particular location. Virtual events may include events that occur on the internet or other similar electronic network such as electronic communications between parties or a proliferation of web sites on a particular topic. Additionally, goal value(s) may be assigned using observations of the frequency of actions. For example, a goal value could be assigned based on the frequency of an action taken by an adversary. The goal value could also be assigned based on the number of actions taken by someone or group. Observations may be collected or measurements made using sensory input collected from one or more sensors. These observations may be collected by the measurement module 360.

At 740, at least one allocated goal value may be determined for at least one of the “including goals”. Each of the “at least one allocated goal value” may be determined by allocating the “goal value” of each of the “included goals” connected to the “at least one including goals” in the “inverse goal lattice” according to a goal value allocation function. The “allocation goal value function” may be implemented in many different ways. For example, the “allocation goal value function” may use one or more of the following functions: a uniform allocation function; a user-allocation function; a non-uniform allocation function; a conservative allocation function; a dynamic allocation function; and a biased allocation function. Each of these functions, either singularly or in combination may be used to allocate the “included goal” values among the “including goals” connected to any “included goal” in an inverse goal lattice 300 structure ordering.

An including goal value may be assigned to each of the “including goals” using: “at least one allocated goal value”; and a least one goal value accrual function at 750. The goal value accrual function may also be implemented in many different ways. For example, the “goal value accrual function” may use individually or in combination some sort or linear or non-linear function. A simple example would be for the “goal value accrual function” to be a summing function. However, one skilled in the art will recognize that more complex functions could be used depending on the particulars of the inverse goal lattice 300. At any point, it may be advantageous to normalize the goal values residing on one or more of levels within the inverse goal lattice 300.

Temporal analysis may also be conducted on the “plurality of goals.” It may also be useful to further identify other systems with at least one similar goal value. These other systems may have an alignment that is important to the first system being analyzed. Similarly, it may also be useful to identify similar inverse goal lattice segments that reside in a different inverse goal lattice which have at least one common included goal and at least one unrelated “including goal”.

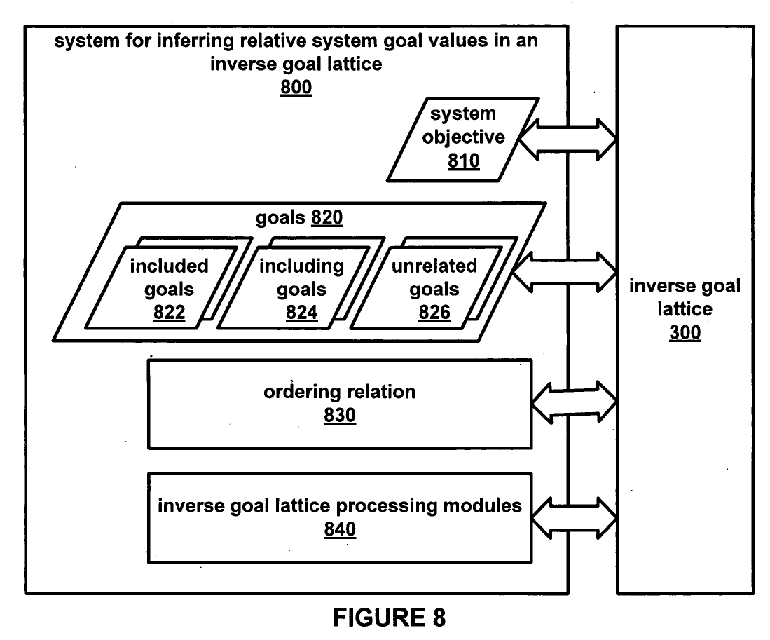

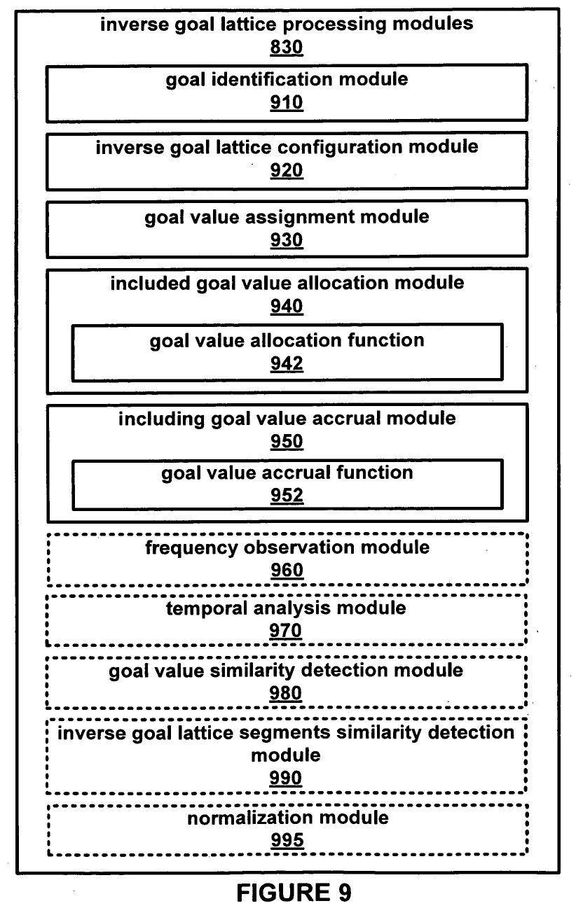

FIG. 8 is block diagrams of a system 800 for inferring relative system goal values in an inverse goal lattice 300 as per an embodiment of the present invention. FIG. 9 expands upon the inverse goal lattice processing modules 840. One embodiment of system embodiment 800 includes: a goal identification module 910, an inverse goal lattice configuration module 920, a goal value assignment module 930, an included goal value allocation module 940, and an including goal value assignment module 950.

The goal identification module 910 may be configured to identify a plurality of goals 820 for accomplishing at least one system objective 810. The “plurality of goals” 820 may include: including goals 824, included goals 810, and unrelated goals 826.

The inverse goal lattice configuration module 920 may be configured to apply an ordering relation 830 to the “plurality of goals” 820 to configure the inverse goal lattice 300. The inverse goal lattice 300 interconnects the “plurality of goals” 820. Further, the inverse goal lattice 300 may be: configured to have at least two levels (see 120, 130 and 140); configured to have at least one of the including goals 824 on a higher level of the two level(s) where at least one of the including goals 824 corresponds to at least one of the objective(s); and configured to have at least one of the “included goals” on the lower level of the two level(s).

The goal value assignment module 930 may be configured to assign a goal value to each of the plurality of goals 820 that are not connected to one of the included goal 822. Basically, this goal value assignment module assigns values to the included goals that are a lowest level of an ordered segment with the inverse goal lattice 300.

The included goal value allocation module 940 may be configured to determine at least one allocated goal value for at least one of the including goals 824, where each of the allocated goal value(s) is determined by allocating the goal value of each of the included goals 822 connected to the including goal(s) 824 in the inverse goal lattice 300 according to a goal value allocation function 924.

The including goal value accrual module 950 may be configured to assign an including goal value to including goal(s) 824 using: allocated goal value(s) and at least one goal value accrual function. The goal value accrual function may also be implemented in many different ways. For example, the “goal value accrual function” may use, individually or on combination, some sort or linear or non-linear function. A simple example would be for the “goal value accrual function” to be a summing function. However, one skilled in the art will recognize that more complex functions could be used depending on the particulars of the inverse goal lattice 300.

In addition to the basic processing modules 830 already described, alternative embodiments of the present invention may use additional modules. FIG. 9 shows four examples of possible additional processing modules: a frequency observation module 960, a temporal analysis module 970, a goal value similarity detection module 980, an inverse goal lattice segments similarity detection module 990, and a normalization module 995.

The normalization module 995 may be configured to normalize the goal values residing on one of the at least two levels. The frequency observation module 960 may be configured to assign at least one goal value to one of the plurality of goals 820 that are not connected to one of the included goal(s) 822 using observations of the frequency of actions taken by an adversary. The temporal analysis module 970 may be configured to perform a temporal analysis of at least one of the plurality of goals 820. The goal value similarity detection module 980 may be configured to identify other systems with at least one similar goal value. The inverse goal lattice segments similarity detection module 990 may be configured to identify similar inverse goal lattice segments residing in a different inverse goal lattice which have at least one common included goal and at least one unrelated including goal.

In this specification, “a” and “an” and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e., hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A method for inferring relative system goal values in an inverse goal lattice, comprising:
a) identifying a plurality of goals for accomplishing at least one system objective, the “plurality of goals” including:
i) including goals;
ii) included goals; and
iii) unrelated goals;
b) applying the “ordering relation” to the “plurality of goals” to configure the inverse goal lattice that interconnects the “plurality of goals”, the “inverse goal lattice:
i) configured to have at least two levels,
ii) configured to have at least one of the “including goals” on a higher level of the “at least two levels”, at least one of the at least one “including goals” corresponding to at least one of the at least one system objective; and
iii) configured to have at least one of the “included goals” on the lower level of the “at least two levels”; and
c) assigning a goal value to each of the “plurality of goals” that are not connected to an included goal;
d) determining at least one allocated goal value for at least one of the “including goals”, each of the “at least one allocated goal value” determined by allocating the “goal value” of each of the “included goals” connected to the “at least one including goals” in the “inverse goal lattice” according to a goal value allocation function; and
e) assigning an including goal value to each of the “including goals” using:
i) “at least one allocated goal value”; and
ii) a least one goal value accrual function.

2. The method of claim 1, wherein the “inverse goal lattice” is configured in a hardware programmable device.

3. The method of claim 1, wherein the “allocation goal value function” is at least one of the following:
a) a uniform allocation function;
b) a user-allocation function;
c) a non-uniform allocation function;
d) a conservative allocation function;
e) a dynamic allocation function; and
f) a biased allocation function.

4. The method of claim 1, wherein at least one of the at least one “goal value accrual function” is a summing function.

5. The method of claim 1, further including normalizing the goal values residing on one of the at least two levels.

6. The method of claim 1, wherein at least one goal value is assigned to one of the “plurality of goals” that are not connected to an included goal using observations of the frequency of actions taken by an adversary.

7. The method of claim 1, wherein at least one goal value is assigned to one of the “plurality of goals” that is not connected to an included goal using sensory input collected from different sensors.

8. The method of claim 1, further including performing a temporal analysis of at least one of the “plurality of goals”.

9. The method of claim 1, further including identifying other systems with at least one similar goal value.

10. The method of claim 1, further including identifying similar inverse goal lattice segments residing in a different inverse goal lattice which have at least one common “included goal” and at least one unrelated “including goal”.

11. A system for inferring relative system goal values in an inverse goal lattice, comprising:
a) a goal identification module configured to identify a plurality of goals for accomplishing at least one system objective, the “plurality of goals” including:
i) including goals;
ii) included goals; and
iii) unrelated goals;
b) an inverse goal lattice configuration module configured to apply an “ordering relation” to the “plurality of goals” to configure the inverse goal lattice that interconnects the “plurality of goals”, the “inverse goal lattice:
i) configured to have at least two levels,
ii) configured to have at least one of the “including goals” on a higher level of the “at least two levels”, at least one of the at least one “including goals” corresponding to at least one of the “at least one system objective”;
iii) configured to have at least one of the “included goals” on the lower level of the “at least two levels”; and
c) a goal value assignment module configured to assign a goal value to each of the “plurality of goals” that are not connected to an included goal;
d) an included goal value allocation module configured to determine at least one allocated goal value for at least one of the “including goals”, each of the “at least one allocated goal value” determined by allocating the “goal value” of each of the “included goals” connected to the “at least one including goals” in the “inverse goal lattice” according to a goal value allocation function; and
e) an including goal value accrual module configured to assign an including goal value to each of the “including goals” using:
i) “at least one allocated goal value”; and
ii) a least one goal value accrual function.

12. The system according to claim 11, wherein the “allocation goal value module” uses at least one of the following:
a) a uniform allocation function;
b) a user-allocation function;
c) a non-uniform allocation function;
d) a conservative allocation function;
e) a dynamic allocation function; and
f) a biased allocation function.

13. The system according to claim 11, wherein at least one of the at least one “goal value accrual module” uses a summing function.

14. The system according to claim 11, further including a normalization module configured to normalize the goal values residing on one of the “at least two levels”.

15. The system according to claim 11, further including a frequency observation module configured to assign at least one goal value to one of the “plurality of goals” that are not connected to an included goal using observations of the frequency of actions taken by an adversary.

16. The system according to claim 11, wherein at least one goal value is assigned to one of the “plurality of goals” that is not connected to an included goal using sensory input collected from different sensors.

17. The system according to claim 11, further including a temporal analysis module configured to perform a temporal analysis of at least one of the “plurality of goals”.

18. The system according to claim 11, further including a goal value similarity detection module configured to identify other systems with at least one similar goal value.

19. The system according to claim 11, further including an inverse goal lattice segments similarity detection module configured to identify similar inverse goal lattice segments residing in a different inverse goal lattice which have at least one common included goal and at least one unrelated “including goal”.
